(19) United States
(12) Patent Application Publication
(10) Pub. No.: US 2026/0072964 A1
(43) Pub. Date: Mar. 12, 2026

(54) Content Referencing System

(71) Applicant: Textron Aviation Inc., Wichita, KS (US)

(72) Inventors: Demetrias Lynn Jones, Wichita, KS (US); Josh Wayne Raiburn, Wichita, KS (US); Geoff Acheson Bleakley, Wichita, KS (US); Spencer William Kraus, Wichita, KS (US); Leslie Lee Rowland, Hurst, TX (US)

(21) Appl. No.: 18/827,106

(22) Filed: Sep. 6, 2024

(51) Int. Cl. G06F 16/33; G06F 3/0482; G06F 16/34

(52) U.S. Cl. CPC G06F 16/3344; G06F 3/0482; G06F 16/345

(57) ABSTRACT

A system and method for a content referencing system. The content referencing system includes a user interface which can receive and input a text string and index selection into a language model. The language model can compute a summary response which can be displayed on the user interface and corresponds to the text string and index selection.

### BACKGROUND

### 1. Field Embodiments of the disclosure relate generally to the field of aircraft maintenance and, more specifically, to reference systems that search content related to aircraft maintenance.

### 2. Description of the Related Art

Various solutions have been proposed for having content referencing systems. For instance, a content referencing system can search sources of information. These systems may include control modules that can move seats or tray tables. The controls can also activate/deactivate light sources and perform combinations thereof based on the activity data. Additionally, cabin service systems may control cabin audio systems, passenger and cabin lighting, and in-flight entertainment subsystems.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

In some embodiments, the techniques described herein relate to a method for a content referencing system, the method including: generating a user interface (UI) including a dialog window and an input field onto a display; receiving, via the UI, a text string inputted into the input field; inputting the text string, and data points from a selected index associated with the text string, into a language model; outputting, via the language model, a summary response associated with the text string and the selected index data points; and causing the UI to display the summary response in the dialog window.

In some embodiments, the techniques described herein relate to a method wherein the summary response includes a reference to the selected index data points used by the language model to produce the summary response.

In some embodiments, the techniques described herein relate to a method, further including: generating, via the UI, a drop down menu icon including a selectable list of searchable indexes; receiving, via the UI, an index selection from the searchable indexes included in the drop down menu icon; and applying the index selection as the selected index prior to inputting the selected index data points into the language model.

In some embodiments, the techniques described herein relate to a method, further including: generating, via the UI, a drop down menu icon including a selectable list of searchable aircraft; receiving, via the UI, an aircraft model selection from the searchable aircraft included in the drop down menu icon; and inputting the aircraft model selection with the selected index to further filter the selected index data points and the text string into the language model.

In some embodiments, the techniques described herein relate to a method, wherein the summary response includes a reference to documentation associated with the selected index.

In some embodiments, the techniques described herein relate to a method, wherein the reference includes a hyperlink to a section of the documentation associated with the summary response.

In some embodiments, the techniques described herein relate to a method, wherein the selected index includes embeddings from aircraft-related documentation associated with the selected index.

In some embodiments, the techniques described herein relate to a method, wherein the language model is configured to generate a search query and summarize the selected index data points to produce the summary response.

In some embodiments, the techniques described herein relate to a method, further including: analyzing an intent associated with the text string; and determining the selected index based, at least in part, on the intent prior to inputting the selected index data points into the language model.

In some embodiments, the techniques described herein relate to a method, further including: analyzing an intent associated with the text string; referencing a historical input associated with prior text string submissions within a period of time; and determining the selected index based, at least in part, on the intent and the historical input prior to inputting the selected index data points into the language model.

In some embodiments, the techniques described herein relate to a content referencing system, the system including: a user interface (UI) configured with a display including a dialog window and an input field, wherein the input field is configured to receive a text string; a language model configured to: receive selected index data points and the text string; and output a summary response associated with at least the selected index data points and the text string.

In some embodiments, the techniques described herein relate to a system, wherein the UI is further configured to display a drop down menu icon including a selectable list of searchable indexes, wherein the searchable indexes include embeddings from aircraft maintenance documentation associated with the searchable indexes, respectively.

In some embodiments, the techniques described herein relate to a system, wherein an intent analyzer includes pointers corresponding to the text string and the pointers provide indication of what searchable indexes to search for data points to provide to the language model.

In some embodiments, the techniques described herein relate to a system wherein the language model is configured to determine an intent associated with the text string and determine an index corresponding to the intent prior to inputting the index data points into the language model.

In some embodiments, the techniques described herein relate to a system, wherein the language model suppresses the summary response when the text string is not associated with the index data points.

In some embodiments, the techniques described herein relate to a computer program product for a content referencing system, the computer program product including a computer readable storage medium having computer readable instructions stored therein, wherein the computer readable instructions, when executed on a computing device, causes the computing device to: receive an input of index data points and a text string associated with an aircraft via a user interface (UI); and output, to the UI, a summary response produced by a language model using the text string and the index data points as input.

In some embodiments, the techniques described herein relate to a computer program product, further including: generate an intent associated with the text string; and determine the index based, at least in part, on the intent prior to inputting the index data points into the language model.

In some embodiments, the techniques described herein relate to a computer program product, wherein the index includes embeddings from aircraft-related documentation associated with the index.

In some embodiments, the techniques described herein relate to a computer program product including an intent analyzer configured to determine the intent and provide indication to the language model of portions of the index associated with the text string.

In some embodiments, the techniques described herein relate to a computer program product wherein the summary response includes references to documentation associated with the index.

### BRIEF DESCRIPTION OF THE SEVERAL VIEWS OF THE DRAWINGS

Embodiments of the disclosure are described in detail below with reference to the attached drawing figures, wherein:

FIG. 1 illustrates a content referencing system, in accordance with embodiments of the present disclosure.

FIG. 2 illustrates a process flow chart for having the content referencing system.

FIG. 3 illustrates a process flow chart for having the content referencing system.

FIG. 4 illustrates a use case sequence diagram for having the content referencing system.

FIG. 5 illustrates a block diagram of an exemplary computing device, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The following detailed description references the accompanying drawings that illustrate specific embodiments in which the disclosure can be practiced. The embodiments are intended to describe aspects of the disclosure in sufficient detail to enable those skilled in the art to practice the disclosure. Other embodiments can be utilized, and changes can be made without departing from the scope of the disclosure. Therefore, the following detailed description is not to be taken in a limiting sense. The scope of the disclosure is defined only by the appended claims and the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

This disclosure relates generally to content referencing systems and, more specifically, to methods and systems that reference indexes and output summary responses corresponding to a text string input into an interface. The following description is directed to some particular examples of innovative aspects of this disclosure. However, a person having ordinary skill in the art will readily recognize that the teachings herein can be applied in a multitude of different ways.

### Overview

Embodiments disclosed herein provide a system and a method for having a content referencing system, which uses a language model to generate a summary response associated with a text string and index, which can be input into a user interface. In embodiments, the content referencing system includes indexes that can have information pertaining to an aircraft and, more specifically, can include documentation which refers generally to all forms of written materials and records that provide guidance, procedures, and historical information related to the maintenance of equipment, systems, or facilities. The documentation can also include maintenance manuals, operating procedures, service records, inspection logs, and technical bulletins. The content referencing system may be accessed via a user interface in which a text string, possibly relating to aircraft maintenance, can be input to the language model, and a summary response associated with the text string can be output by the language model and displayed on the user interface. Advantageously, the content referencing system provides a way to search and quickly reference aircraft maintenance records/information, which can decrease troubleshooting time and increase productivity of service technicians.

Various aspects of the disclosure improve existing technologies, as well as others, by providing methods, components, and systems that support the content referencing system. The content referencing system provides improvements to aircraft maintenance procedures, which are described in embodiments herein including using a language model to locate sections of indexes corresponding to a text string input and selected index, and then outputting a summary response.

In some embodiments, the summary response includes references to an index associated with the logic used by the language model to produce the summary response. Embeddings are used to determine the data points within the index to pass context or data points to the language model. Embeddings can also be used to produce a summary response and can produce references corresponding to the embeddings to be included in the summary response. For instance, references can correspond to sections or sentences in an aircraft document which can be a manual corresponding to a text string input into the user interface.

In some embodiments, the user interface can generate a drop-down menu icon that includes a selectable list of searchable indexes, which can include references to documentation including manuals, records, and procedures having information for specific types of aircraft. The drop-down menu generated by the user interface can allow for a selection of a specific aircraft model. A selection corresponding to an aircraft model can be inputted into the language model to produce a summary response associated with the index and corresponding aircraft. The selection using a drop-down menu can further refine and associate the summary response with a specific manual, record, or procedure.

In some embodiments, the content referencing system is configured to analyze the text string input and determine an intent associated with the text string and can determine an index corresponding to the intent prior to inputting the index into the language model. For instance, an intent can be recognized by the content referencing system as an input which can ask how to perform a task, for a solution to a problem, or for a part number lookup. The content referencing system can determine the index based on the intent before inputting the index into the language model using an intent analyzer. In some examples, a text string history can be referenced by the content referencing system to identify an intent and index. In some embodiments, the text string history can include previous text strings input in a current session and query. In other embodiments the text string history can include text strings input during previous sessions and queries As such, particular aspects of the subject matter described in this disclosure can be implemented to realize one or more of the following potential advantages. The present disclosure aims to provide a content referencing system to decrease troubleshooting and service time for aircraft maintenance servicing by inputting questions or remarks in the form of text strings and associated index data points into a language model. The system can search the indexes and output a summary response associated with the question or remark posed to the system. This functionality allows for service technicians to spend less time consulting documentation and more time working hands-on with the aircraft and substantially allows technicians to be more efficient and productive.

### Example Content Referencing System

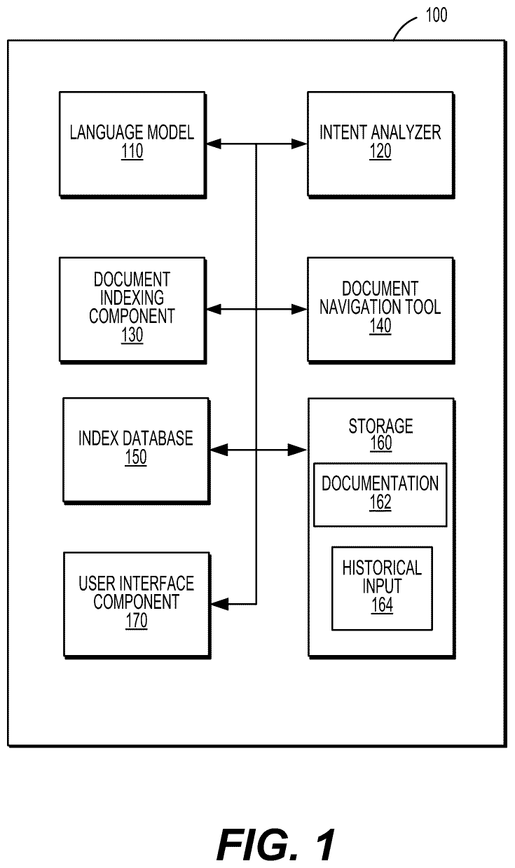

Referring to FIG. 1, a block diagram of an example content referencing system suitable for use in implementing embodiments of the disclosure is shown. The content referencing system 100 is configured to provide information corresponding to components associated with an aircraft based on an input. The content referencing system 100 can utilize a text string and index data point inputs into a language model to output a summary response having information corresponding to the inputs. The summary response can provide references and links to aircraft documentation including manuals, service squawks, reports, records, and procedures related to the text string input which can substantially reduce the amount of time necessary for personnel to consult manuals, records, and procedures.

The content referencing system 100 includes a user interface 170, a language model 110, an intent analyzer 120, a document indexing component 130, a document navigation tool 140, an index database 150, and storage 160. In embodiments, the user interface 170 can be transmitted and shown on a display which displays the document indexing component 130, document navigation tool 140 and an output/dialog window.

In embodiments, user interface 170 is communicatively connected to language model 110 such that information input to the document indexing component 130, and document navigation tool 140 can be communicated to language model 110. The language model 110 can communicate an output to be displayed in a dialog window related to the inputs received. In some embodiments, user interface 170 may be configured on a human-machine interface which includes an interactive display.

In some embodiments, a text string input may be input into the user interface 170 using the document indexing component 130, which may have an input field configured on the display. A text string input may be a question relating to an aircraft or aircraft component. For example, a text string input may ask how to perform a task, ask for a solution to a problem, or ask for a part number associated with an aircraft component. In some examples, a text string input may be a question such as “How do I flush the landing gear emergency extensions?” or “What is the cause of the propeller spinning at an incorrect speed?” or “What is the part number of the aircraft cowl?” A text string input may be input by a service technician into user interface 170 and can be input manually or by using voice recognition technologies.

In some embodiments, an index selection will be made from the user interface 170 displaying indexes from an index database 150. The user interface 170 can include a list which may be a drop-down menu icon including a selectable list of searchable documentation 162 stored in storage 160 and searchable in the index database 150. For instance, the list of searchable documentation may be a list of searchable aircraft manuals relating to aircraft models or different types of aircraft whose information is contained in documentation 162 stored in storage 160 and referenced in the index database 150. Documentation 162 generally refers to all forms of written materials and records that provide guidance, procedures, and historical information related to the maintenance of equipment, systems, or facilities. The documentation can also include maintenance manuals, operating procedures, service records, inspection logs, and technical bulletins. In some embodiments, index database 150 can relate to the text string input and can correspond to an intent of the text string input. For example, a service technician can make an index selection corresponding to a specified aircraft by selecting an index from the user interface 170. In embodiments, the user interface 170 may or may not be used to select an index.

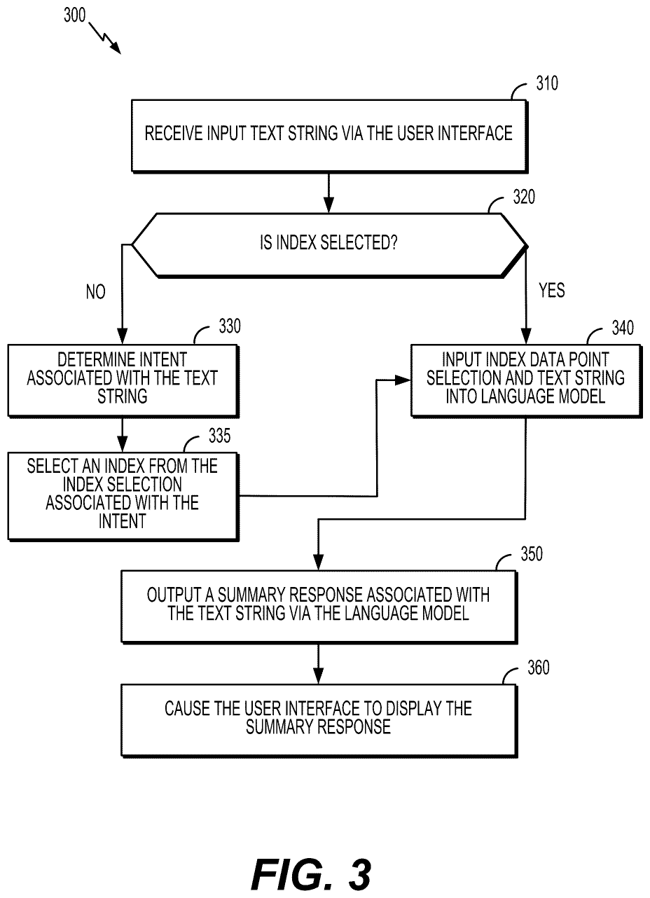

In some embodiments, index selection is determined/selected by an intent analyzer 120 determining an intent associated with the document indexing component 130, which may be a text string input (see FIG. 3). For instance, intent analyzer 120 can be configured to associate a text string input to document indexing component 130 with an intent such as whether the input is searching for instructions, diagnosing a problem, or part lookup. The intent analyzer 120 is configured to reference the index database 150 in instances when an index selection using the user interface 170 is not made by a service technician or user. In some embodiments, intent analyzer 120 can include pointers corresponding to a text string input which can provide indication to the language model 110 of portions of index database 150 related to the text string input. For instance, a text string using document indexing component 130 may be entered relating to replacing an aircraft part, such as a propeller, and the intent analyzer 120 can determine an index in the index database 150 related to replacing the propeller of the aircraft. If the text string specifies a model or type of aircraft the intent analyzer 120 can additionally find documentation loaded into index database 150 corresponding to the specified type of aircraft.

In some embodiments, index database 150 can be a vector database configured to provide storage, configuration, and query capabilities for vector searches (i.e. text string searches). In some embodiments, index database 150 can include aircraft documentation 162, which can include manuals, service squawks, and customer service documents which are loaded into the database and stored in storage 160 to be referenced by the language model 110. The index database 150 can include embeddings corresponding to aircraft documentation 162 and other forms of written materials and records that provide guidance, procedures, and historical information related to the maintenance of equipment, systems, or facilities In some embodiments, storage 160 can include documentation 162 and historical input 164. Documentation 162 can include manuals and sources of information about aircraft or specific types of aircraft. Maintenance reports, service squawks, operation manuals and other reports or sources of information can be included in documentation 162. Historical input 164 can be an input history such as prior text strings input to the user interface component 170. In some embodiments, the historical input 164 corresponds to a current session. For instance, if a fourth consecutive text string in input into user interface 170, the previous three text strings input can be referenced as historical input 164 which provide the language model 110 with the current session history.

The index selection made using the user interface 170 can be received by language model 110 as index data points and provide information for the language model 110 to output a summary response to, in some embodiments, a dialog window configured with the user interface 170. The language model 110 is configured, in some cases, to receive an index data points from the selected index database 150 and a text string input from the user interface 170. Language model 110 may be a large language model and, in embodiments, can include a generating pretraining transformer and automated data processing system configured to process a text string input and index data point selections. The language model 110 is configured to produce a summary response which can be displayed in a dialog window on user interface 170.

In some embodiments a summary response can include one or more references which correspond to the index database 150. For instance, a reference in the summary response may be a hyperlink to the document navigation tool 140 or service squawk, or customer service report stored in storage 160 and searchable in index database 150. In some embodiments, a reference in the summary response may be displaying the reference on screen in the user interface 170. This substantially allows a user to reference relevant sections of index database 150 using summary response. In some embodiments, summary response may include text strings related to sections of index database 150 determined to be relevant to text string input by language model 110.

It is noted that FIG. 1 is intended to depict the major representative components of a content referencing system 100. In some embodiments, however, individual components may have greater or lesser complexity than as represented in FIG. 1, components other than or in addition to those shown in FIG. 1 may be present, and the number, type, and configuration of such components may vary.

### Example Flow Diagrams

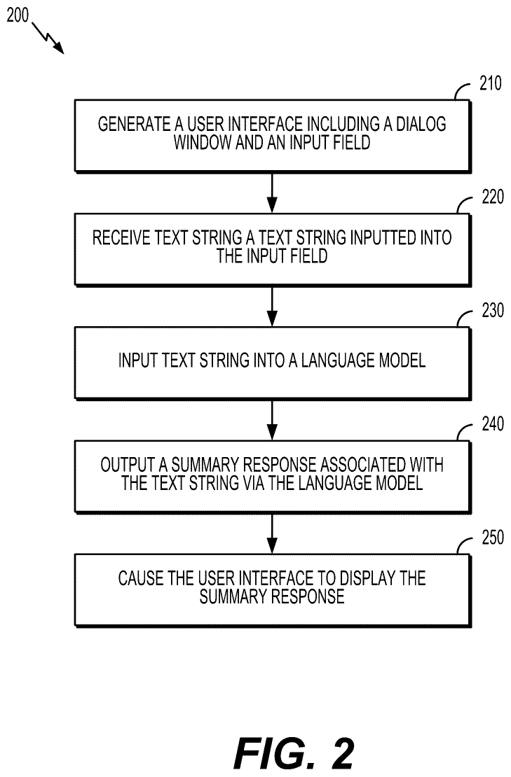

With reference to FIG. 2, a flow diagram is provided illustrating a method 200. Each block of the method 200 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media.

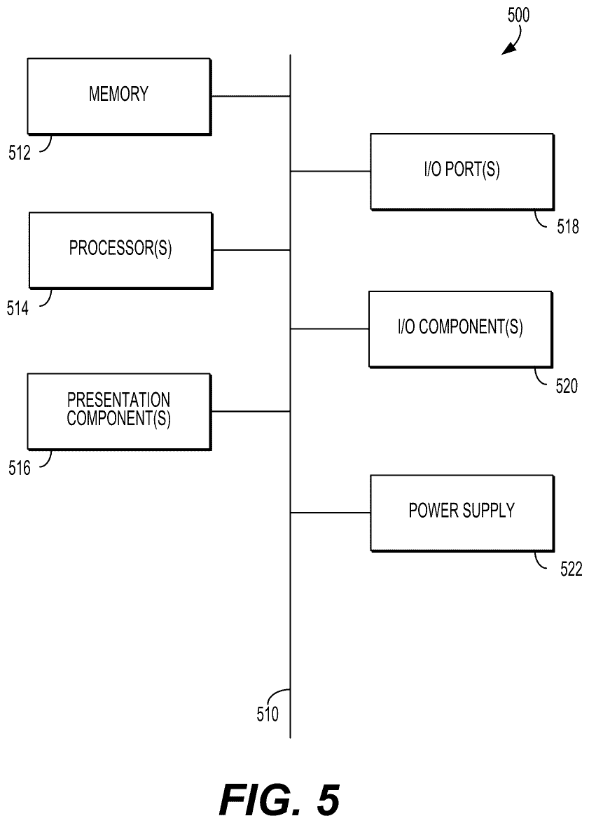

FIG. 2 illustrates a method 200 of a series of acts in a method of a content referencing system, in accordance with embodiments of the present disclosure. In one or more embodiments, the method 200 may be performed by a computing device such as the one of the computing device 500, described with reference to FIG. 5. The method 200 is intended to be illustrative of one or more methods in accordance with the present disclosure and is not intended to limit potential embodiments. Alternative embodiments can include additional, fewer, or different steps than those articulated in FIG. 2.

As illustrated in FIG. 2, the method 200 includes a block 210 which generates a user interface. In embodiments, the user interface 170 can include an input field and dialog window viewable on a display. In some embodiments, the user interface 170 can be viewed on a screen or monitor such that it is viewable by a user. In some embodiments, the user interface 170 can include a selectable list of searchable indexes within index database 150.

At block 220, the content referencing system 100 receives a text string input into the user interface 170. In some embodiments, the text string input may be a question directed towards an aircraft or an aircraft maintenance issue. For instance, a text string input may ask how to perform a task, ask for a solution to a problem, or ask for a part number associated with an aircraft component.

At block 230, a text string input and selected index data points possibly associated with the text string are input into language model 110. In some embodiments, the selected index data points input into language model 110. In other embodiments, an index from index database 150 may not be selected by a user (see FIG. 3), in which case, the language model 110 can determine an intent using intent analyzer 120 and select an index from index database 150. In some embodiments, intent analyzer 120 can include pointers corresponding to the text string input and which provide indication to the language model 110 of portions of index database 150 related to the text string input. In some embodiments, intent analyzer 120 can include an API layer configured to determine an intent associated with text string input and/or an index selection. In embodiments, language model 110 may be a large language model and can include a generating pretraining transformer.

At block 240, the language model 110 outputs a summary response. In embodiments, summary response may include text, references, and/or hyperlinks corresponding to service reports or squawks which are stored in storage 160. The summary response can correspond to index database 150 and an index associated with the text string input. More specifically, the summary response can include references to specific sections of index database 150 as determined by language model 110 and inputs from the document indexing component 130 and document navigation tool 140. In some embodiments, intent analyzer 120 can derive an intent associated with text string input and the summary response can be based on the intent. In some embodiments, language model 110 may suppress outputting a summary response if the text string input is not associated with an index within index database 150.

At block 250, the summary response is displayed on the user interface 170. In embodiments, the user interface 170 can display the summary response in a dialog window. The user interface 170 may be configured on a human machine interface with an interactive display or screen.

With reference to FIG. 3, a flow diagram is provided illustrating a method carried out by content referencing system 100. Each block of the method 300 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media.

FIG. 3 illustrates a method 300 of a series of acts in a method of a content referencing system, in accordance with embodiments of the present disclosure. In some examples, the method 300 may be performed by a computing device such as the one of the computing device 500, described with reference to FIG. 5. The method 300 is intended to be illustrative of one or more methods in accordance with the present disclosure and is not intended to limit potential embodiments. Alternative embodiments can include additional, fewer, or different steps than those articulated in FIG. 3.

At block 310, a text string input may be input into user interface 170. In embodiments, text string input may be entered into an input field on a display displaying the user interface 170. In some embodiments, the text string input may be a question directed towards an aircraft or an aircraft maintenance issue. For instance, a text string input may ask how to perform a task, ask for a solution to a problem, or ask for a part number associated with an aircraft component.

At block 320, the content referencing system 100 recognizes if an index selection has been made using the user interface 170. For example, the user interface 170 can be a selectable list of searchable indexes.

If an index selection has been made at block 320 the method proceeds to block 340. If an index selection has not been made at block 320, the method 300 proceeds to block 330. At block 330, the intent analyzer 120 analyzes and determines an intent of the text string input inputted at block 310 to make an index selection from the index database 150. For instance, intent analyzer 120 can be configured to associate the text string input with an intent such as whether the input is searching for instructions, diagnosing a problem, or part lookup. In some embodiments, intent analyzer 120 can include pointers corresponding to the text string input which provide indication to the language model 110 of portions of index database 150 related to text string input. The intent analyzer 120 is configured to reference index database 150 to make an index selection in instances when an index is not selected from user interface 170. The method 300 then proceeds to block 335.

At block 335, the intent analyzer 120 selects an index from the index database 150 associated with the intent. In some embodiments, intent analyzer 120 can include pointers corresponding to the text string input which provide indication to the language model 110 of portions of index database 150 related to text string input. The pointers can reference documentation 162 and/or historical input 164 in storage 160.

At block 340, the index selection data points (either selected by a user using the user interface 170 or determined by intent analyzer 120) and text string input are input into the language model 110. As described above with reference to FIGS. 1 and 2, language model 110 can be a large language model and can include a generating pretraining transformer and automated data processing system configured to process text string input and index selection.

At block 350, the language model 110 outputs a summary response. In embodiments, the summary response can include one or more references, determined by language model 110, to correspond to an index selection. For instance, a reference in the summary response may be a hyperlink to documentation 162, including a manual, service squawk, or customer service report loaded into the index database 150. In some embodiments, a reference in the summary response may include displaying the reference from documentation 162, service squawk, or customer service report loaded into the index database 150 displayed on user interface 170. This substantially allows a user to reference relevant sections of index database 150 using the summary response. In some embodiments, the summary response may include text strings related to sections of index database 150 determined to be relevant to text string input by language model 110.

At block 360, the summary response is displayed on a display. In embodiments, the user interface 170 can display the summary response in a dialog window on a display. The display may be configured on a human machine interface with an interactive display or screen.

### Example Use Case Sequence Diagram

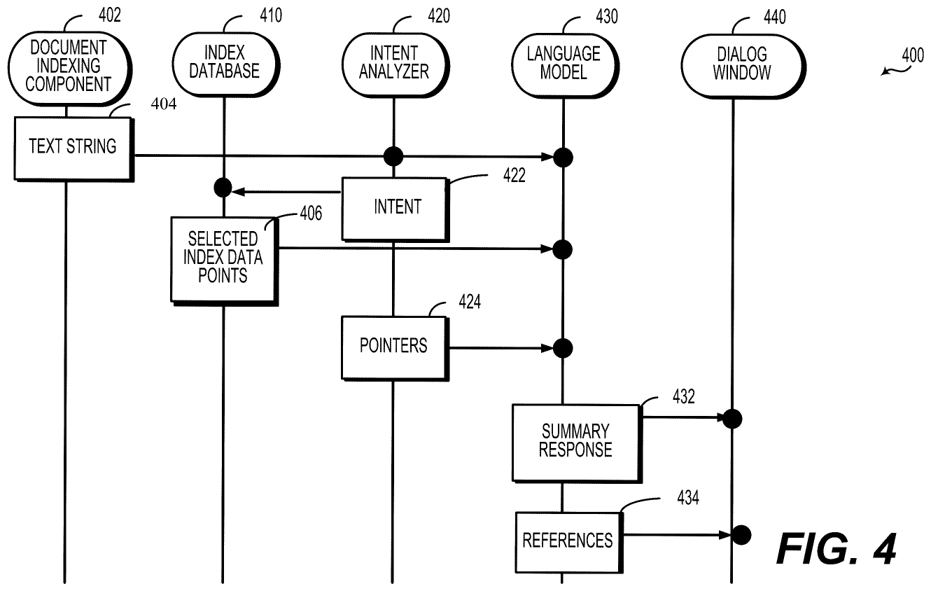

FIG. 4 shows a sequence diagram 400 of an example use case scenario of a system creating content referencing system 100, respectively, in accordance with embodiments of the present disclosure. According to some aspects, the sequence diagram 400 represents a procedure that can occur to between components of the content referencing system, which allows for the exchange of information including, analyzing an input text string, and outputting and displaying a summary response. The summary response can include references to loaded indexes and can locate information stored in loaded indexes. Additionally, in some aspects, the sequence diagram 400 illustrates how performing aircraft maintenance procedures can be optimized such that less time is spent consulting aircraft documentation such as manuals, squawks, and customer reports and more time is spent working hands on with the aircraft.

As shown the sequence diagram 400 includes a language model 430 capable of receiving inputs from a document indexing component 402, index database 410, or intent analyzer 420 and outputting a summary response 432 to a dialog window 440. The language model 430 may be a large language model and can include a generating pretraining transformer. In embodiments, document indexing component 402 can include a text string input 404 which is communicated to intent analyzer 420 and language model 430. In some embodiments, text string input 404, may be a question directed towards an aircraft or an aircraft maintenance issue. For instance, a text string input 404 may ask how to perform a task, ask for a solution to a problem, or ask for a part number associated with an aircraft component.

In some embodiments index database 410 includes selected index data points 406. In some embodiments, selected index data points 406 can be selected from index database 410, or can be determined by intent analyzer 420. The index database 410 may be arranged and displayed in a menu having a drop-down menu icon which includes a selectable list of searchable indexes included in the index database 410. For instance, the list of searchable indexes may be a list of documentation 162 including searchable manuals having information relating to aircraft models or different types of aircraft. The intent analyzer 420 is configured to receive and analyze the text string input 404 to determine an intent 422 of text string input 404. In some embodiments, the intent 422 can be whether the text string input 404 is searching for instructions, diagnosing a problem, or part lookup. Intent analyzer 420 is configured to determine the intent such that in cases when an index from index database 410 is not selected, the intent 422 can be used to select the selected index data points 406.

In embodiments, the text string input 404 and selected index data points 406 are inputted into language model 430. In some embodiments, intent analyzer 420 can include pointers 424 corresponding to the text string input which provide indication to the language model 110 of portions of index database 150 related to text string input 404. The language model 430 is configured to compute a summary response 432 and output the summary response 432 to a dialog window 440. In some embodiments, the summary response 432 can include references 434 which can be displayed in dialog window 440. In some embodiments, the reference 434 may be to aircraft documentation associated with the summary response. In embodiments, documentation generally refers to all forms of written materials and records that provide guidance, procedures, and historical information related to the maintenance of equipment, systems, or facilities. The documentation can also include maintenance manuals, operating procedures, service records, inspection logs, and technical bulletins. In some embodiments, the dialog window 440 can be displayed on a human machine interface and can be part of a user interface.

### Example Operating Environment

Having described an overview of embodiments of the present technology, an example operating environment in which embodiments of the present technology may be implemented is described in order to provide a general context for various aspects of the present technology. Referring now to FIG. 5, in particular, an exemplary operating environment for implementing embodiments of the present technology is shown and designated generally as computing device 500. Computing device 500 is but one example of a suitable computing environment and is not intended to suggest any limitation as to the scope of use or functionality of the technology. Neither should computing device 500 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 5, computing device 500 includes bus 510 that directly or indirectly couples the following devices: memory 512, one or more processors 514, one or more presentation components 516, input/output ports 518, input/output components 520, and illustrative power supply 522. Bus 510 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 5 merely illustrates an example computing device that can be used in connection with one or more embodiments of the present technology. A distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media.

Computer storage media can include volatile and nonvolatile, removable, and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer storage media in the form of volatile or nonvolatile memory. The memory may be removable, non-removable, or a combination thereof. Examples of hardware devices include solid-state memory, hard drives, optical-disc drives, etc. Computing device 500 includes one or more processors that read data from various entities, such as memory 512 or I/O components 520. Presentation component(s) 516 presents data indications to a user or other device. Examples of presentation components include a display device, speaker, printing component, vibrating component, etc.

I/O ports 518 allow computing device 500 to be logically coupled to other devices, including I/O components 520, some of which may be built in. Illustrative components include a microphone, joystick, game pad, satellite dish, scanner, printer, wireless device, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature”is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed:

1. A method for a content referencing system, the method comprising:
generating a user interface (UI) including a dialog window and an input field onto a display;
receiving, via the UI, a text string inputted into the input field;
inputting the text string, and data points from a selected index associated with the text string, into a language model;
outputting, via the language model, a summary response associated with the text string and the selected index data points; and
causing the UI to display the summary response in the dialog window.

2. The method of claim 1 wherein the summary response includes a reference to the selected index data points used by the language model to produce the summary response.

3. The method of claim 1, further comprising:
generating, via the UI, a drop down menu icon including a selectable list of searchable indexes;
receiving, via the UI, an index selection from the searchable indexes included in the drop down menu icon; and
applying the index selection as the selected index prior to inputting the selected index data points into the language model.

4. The method of claim 1, further comprising:
generating, via the UI, a drop down menu icon including a selectable list of searchable aircraft;
receiving, via the UI, an aircraft model selection from the searchable aircraft included in the drop down menu icon; and
inputting the aircraft model selection with the selected index to further filter the selected index data points and the text string into the language model.

5. The method of claim 1, wherein the summary response includes a reference to documentation associated with the selected index.

6. The method of claim 5, wherein the reference includes a hyperlink to a section of the documentation associated with the summary response.

7. The method of claim 1, wherein the selected index includes embeddings from aircraft-related documentation associated with the selected index.

8. The method of claim 1, wherein the language model is configured to generate a search query and summarize the selected index data points to produce the summary response.

9. The method of claim 1, further comprising:
analyzing an intent associated with the text string; and
determining the selected index based, at least in part, on the intent prior to inputting the selected index data points into the language model.

10. The method of claim 1, further comprising:
analyzing an intent associated with the text string;
referencing a historical input associated with prior text string submissions within a period of time; and
determining the selected index based, at least in part, on the intent and the historical input prior to inputting the selected index data points into the language model.

11. A content referencing system, the system comprising:
a user interface (UI) configured with a display including a dialog window and an input field, wherein the input field is configured to receive a text string;
a language model configured to:
receive selected index data points and the text string; and
output a summary response associated with at least the selected index data points and the text string.

12. The system of claim 11, wherein the UI is further configured to display a drop down menu icon including a selectable list of searchable indexes, wherein the searchable indexes include embeddings from aircraft maintenance documentation associated with the searchable indexes, respectively.

13. The system of claim 11, wherein an intent analyzer includes pointers corresponding to the text string and the pointers provide indication of what searchable indexes to search for data points to provide to the language model.

14. The system of claim 11 wherein the language model is configured to determine an intent associated with the text string and determine an index corresponding to the intent prior to inputting the index data points into the language model.

15. The system of claim 11, wherein the language model suppresses the summary response when the text string is not associated with the index data points.

16. A computer program product for a content referencing system, the computer program product comprising a computer readable storage medium having computer readable instructions stored therein, wherein the computer readable instructions, when executed on a computing device, causes the computing device to:
receive an input of index data points and a text string associated with an aircraft via a user interface (UI); and
output, to the UI, a summary response produced by a language model using the text string and the index data points as input.

17. The computer program product of claim 16, further comprising:
generate an intent associated with the text string; and
determine the index based, at least in part, on the intent prior to inputting the index data points into the language model.

18. The computer program product of claim 16, wherein the index includes embeddings from aircraft-related documentation associated with the index.

19. The computer program product of claim 16 comprising an intent analyzer configured to determine the intent and provide indication to the language model of portions of the index associated with the text string.

20. The computer program product of claim 16 wherein the summary response includes references to documentation associated with the index.
